(19) United States
(12) Patent Application Publication
(10) Pub. No.: US 2009/0227911 A1
(43) Pub. Date: Sep. 10, 2009

(54) Biometric and low restraint continuous passive motion rehabilitation device

(76) Inventors: Varad N. Srivastava, Rockford, IL (US); James J. Foskett, Rockford, IL (US); Michael G. Schneider, Rockford, IL (US); John M. Hahn, Roscoe, IL (US); Greg P. Crowley, Roscoe, IL (US); Jerome K. Aarestad, Escondido, CA (US)

Correspondence Address: Varad N. Srivastava;Ingenium Technologies Corporation, 4216 Maray Drive, Rockford, IL, 61107, US

(21) Appl. No.: 12/380,633

(22) Filed: Mar. 2, 2009

Related U.S. Application Data
(60) Provisional application No. 61/034,193, filed on Mar. 6, 2008.

(51) Int. Cl. A61H 1/02

(52) U.S. Cl. 601/34

(57) ABSTRACT

An active-passive rehabilitation device is disclosed providing natural and relatively unconstrained motion of the treated joint, which promotes drainage and mitigates edema in the extrema. This active-passive rehabilitation device enables the application of adjunctive therapeutic modalities such as cryotherapy units and pneumatic sequential compression devices. Electronic controls allow the active-passive rehabilitation device to be programmed to provide resistive load for Active Range of Motion or Active Resistive Range of Motion (AROM or ARROM) for prescribed therapeutic cycles. Speed, range of motion and therapeutic torque limitations are some of the parameters that may be user controlled and/or programmable. Historical data can be stored in the device and can be downloaded electronically in real-time or at discrete intervals, allowing caretakers to monitor progress and even modify load cycles via electronic communication means. The unit has a lifting provision, can be folded to accommodate storage, and has integrated stabilization and bed attachment devices.

### CROSS-REFERENCE TO RELATED PATENT APPLICATIONS

This patent application claims the benefit of U.S. Provisional Patent Application 61/034,193, filed on Mar. 6, 2008, the entire disclosure of which is hereby incorporated by reference.

### BACKGROUND

The subject matter herein is directed generally to a rehabilitation device for the joint of a user's extremity and, more particularly, to an active-passive rehabilitation device for at least a portion of a user's extremity for therapeutic treatment.

Continuous Passive Motion (CPM) devices for the knee and other extremities are used in the practice of orthopedic surgery, physical therapy and rehabilitative medicine to promote range of motion acquisition in users with injured extremities and/or extremities that have been operated upon. Conventional CPM devices configured for rehabilitation have several problematic characteristics. For example, conventional CPM devices configured for rehabilitation of the knee joint of the user in conventional configurations typically have one or more of the following design characteristics: Positioning the user in the device while the user is lying on his/her back in the supine position; employing restraining straps to the extremity undergoing treatment that are placed at the area of the thigh and/or leg and/or knee and/or ankle-foot, etc.; employing, for example, a foot (plantar surface) brace or other support which may act as an area of force transmission upon the treated extremity during therapeutic flexion motion; and/or positioning the user's leg, ankle, and foot at or below the level of the treatment site of the extremity during all or part of the devices induced cycles of range of motion upon the extremity.

### BRIEF SUMMARY

The subject matter described herein provides features which address one or more of the issues with conventional continuous passive motion devices described hitherto, other beneficial features will be apparent from the subject matter described herein.

The claimed subject matter provides a trough to capture a portion of a user's extremity distal to the joint undergoing rehabilitation. The trough is provided angular motion by a drive either directly or via a drive shaft which connects the drive to the trough. The drive is supported by a base structure either directly through a mounting provision on the drive or via a motor mount bracket to which the drive connects and which in turn is supported by the base structure. The base structure provides support against a supporting platform. Further, a control unit for controlling the angular motion of the trough receives and provides control input and output signals. A user control interface module may be provided as a feature of the rehabilitation device to provide a user with the ability to access certain control inputs which include options to start and stop the therapeutic cycle and may further include access to control inputs for adjusting angular speed, range of motion and therapeutic torque levels. An audio and/or a visual indication of the status of the therapeutic cycle may be provided to the user.

The claimed subject matter further describes a method of rehabilitating a joint of an extremity by providing for a natural range of motion with respect to the user's Coronal plane during the rehabilitation process. Further, the likelihood of dislocation of the extremity during rehabilitation is mitigated by reducing the likelihood of internal rotation of the extremity. This is achieved by providing for inclination of the extremity with respect to the Sagittal plane of the user. In one configuration of the rehabilitation device configured for rehabilitation of the knee joint, the leg is inclined so that the joint is above the user's heart, thereby aiding in drainage from the operative site.

### BRIEF DESCRIPTION OF THE DRAWINGS

The accompanying drawings incorporated in and forming a part of the specification illustrate several aspects of the claimed subject matter and, together with the description, serve to explain the principles of the claimed subject matter. In the drawings:

FIG. 1 is a perspective view schematic drawing of a user in the active-passive rehabilitation device configured for rehabilitation of the knee joint, constructed according to principles of the teachings herein;

FIG. 2 is a side view schematic drawing of the active-passive rehabilitation device configured for rehabilitation of the knee joint, constructed according to the teachings herein;

FIG. 3 is a front view schematic drawing of the active-passive rehabilitation device configured for rehabilitation of the knee joint, constructed according to the teachings herein;

FIG. 4 is a perspective view schematic drawing of a user in the active-passive rehabilitation device configured for rehabilitation of the knee joint, constructed according to the teachings herein;

FIG. 5 is a sectional side view of the active-passive rehabilitation device configured for rehabilitation of the knee joint, constructed according to the teachings herein;

FIG. 6 is an embodiment of an active-passive rehabilitation configured for rehabilitation of the knee device showing a base with extending/retracting stabilizer bars, a cap structure and attachment clamps in accordance with the teachings herein; and

FIG. 7 is a block diagram of a system including an active-passive rehabilitation device, in accordance with the teachings herein.

### DETAILED DESCRIPTION

The embodiments of the claimed subject mater and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be briefly mentioned or omitted so as to not unnecessarily obscure the embodiments of the claimed subject matter described. The examples used herein are intended merely to facilitate an understanding of ways in which the claimed subject matter may be practiced and to further enable those of skill in the art to practice the embodiments of the claimed subject matter described herein. Accordingly, the examples and embodiments herein should not be construed as limiting the scope of the claimed subject matter, which is defined solely by the appended claims and applicable law. Moreover, it is noted that like reference numerals represent similar parts throughout the several views of the drawings.

The figures for example show the preferred embodiment of an active passive rehabilitation device configured for rehabilitation of the knee joint. It is understood that the apparatus and method of rehabilitation described herein can be used for rehabilitation of other joints such as elbow, ankle and shoulder joints. In the description below, a rehabilitation device for the knee joint will be used to describe the features of the claimed subject matter.

As an example, the apparatus described herein can be used in one embodiment for elbow joint rehabilitation wherein at least a part of the radial-ulnar section is supported in the trough and the humeral section of the arm may be supported in the posterior support structure. In another embodiment, the method of rehabilitation described herein can be used for rehabilitation of the shoulder joint.

It is understood that the subject matter claimed is not limited to the particular methodology, protocols, devices, apparatus, materials, applications, etc., described herein, as these may vary. It is also to be understood that the terminology used herein is used for the purpose of describing particular embodiments only, and is not intended to limit the scope of the claimed subject matter. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art.

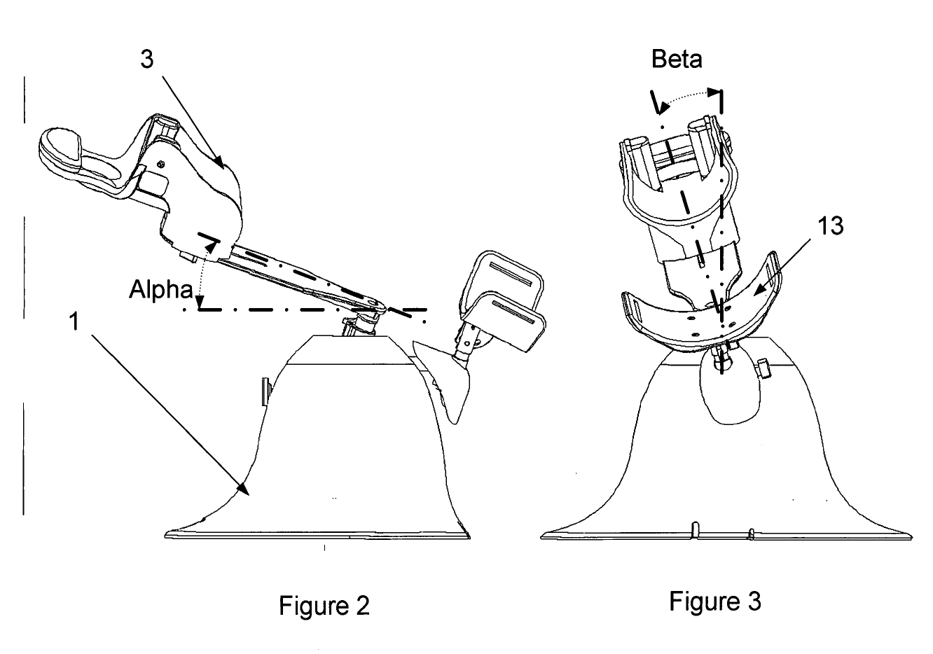

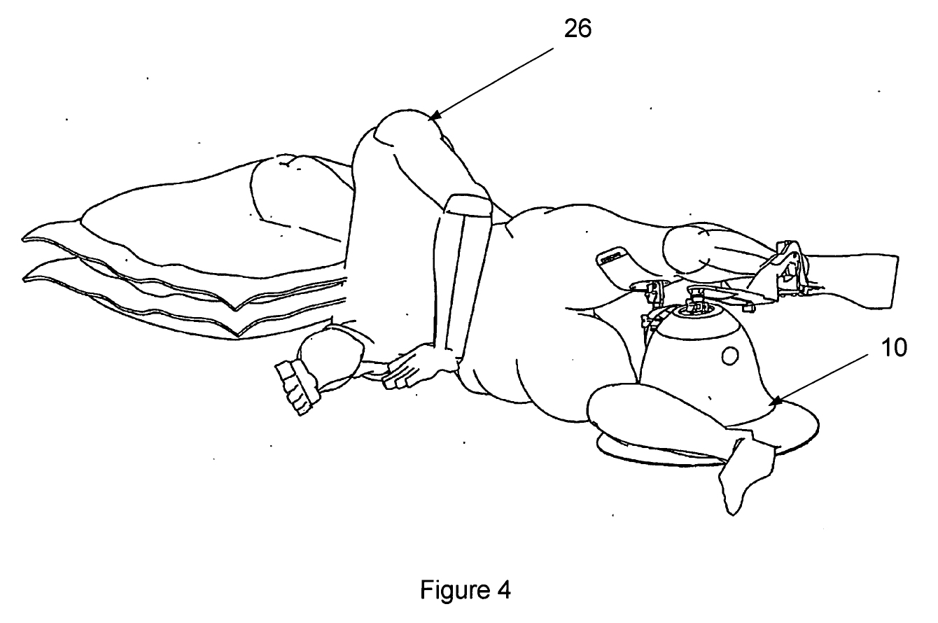

The active-passive rehabilitation device 10 comprises a base structure 1 with generally smooth surfaces which houses a gearbox 8 and motor 7. The drive shaft 2 may be inclined (angle Alpha) to the horizontal plane of the base as seen in FIG. 2, and with the vertical plane (angle Beta) as seen in FIG. 3. The drive shaft rotates the leg trough 3 from approximately −10° to 125° clockwise or anti-clockwise in a left or right leg modality. The rotation control may be based at least in part on control input from the user interface module 4 and use of the left-right leg engage lever 5. The leg trough 3 in one embodiment may be approximately 12-24 inches in length and is shaped to ensure user's comfort and even pressure distribution. The trough structure may be constructed of a rigid plastic, and further may be padded with conformable material such as viscoelastic memory foam and/or a sheepskin material. Different sizes of troughs may be selected for use with different users. Bed attachment clamp 6 may be used in a stowed position or used during operation to provide stability of the active-passive rehabilitation device 10 when used in a bed setting.

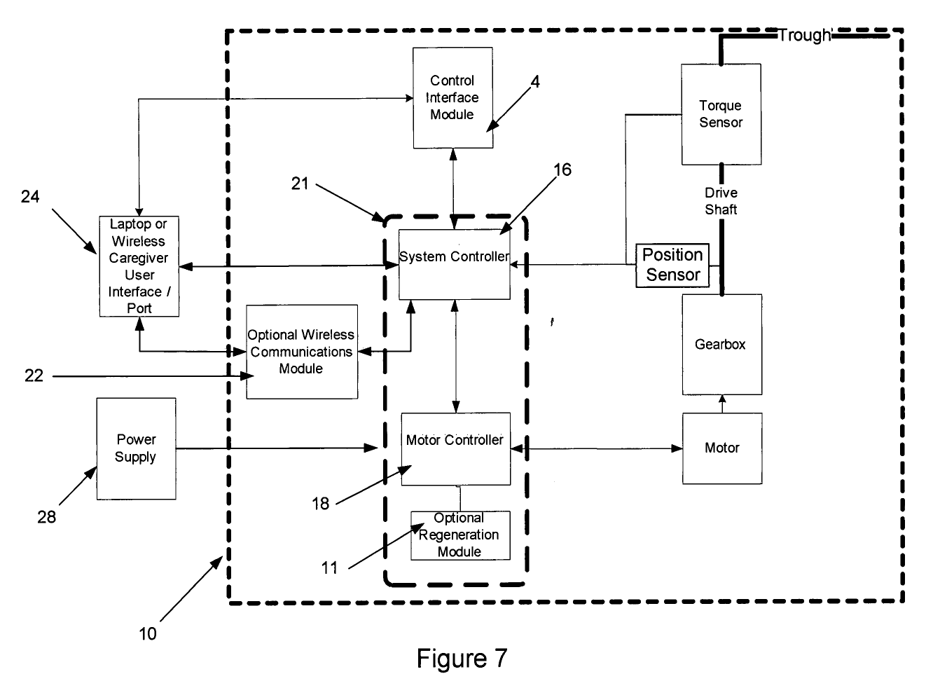

Turning now to FIG. 7, functional block diagrams of several electronic, electro-mechanical and mechanical aspects of the active-passive rehabilitation device are shown including some of the elements that may be incorporated in the rehabilitation device and during use of the device. The electromechanical aspects of the active-passive rehabilitation device may be housed within or proximate the base 1 and may include a control unit 21, a system controller 16, a motor controller 18, a motor 7, a drive mount bracket 23, a gear box 8, a torque sensor 20, position sensor 12, an optional wireless communications module 22 and an optional regeneration module 11. A trough 3 typically receives the distal portion of a user's extremity. Also shown, typically not included as part of the base 1, may be an external power supply 28, and a laptop or other computing device 24 to interface to the electromechanical aspects via control unit 21 of the active-passive rehabilitation device 10 for programming, extracting information from, and controlling the overall operations of the active-passive rehabilitation device 10. Computing device 24 may be any device that has the capability to perform the functions described above.

A primary function of the active-passive rehabilitation device 10 in one embodiment is to aid in physical therapy of users who have had knee surgery by articulating the user's lower leg in order to increase the range of motion in the knee joint. Additionally, the device 10 can provide resistance to leg motion, resulting in strengthening leg muscles.

The user or a caregiver (e.g., therapist, nurse, etc.) may control operation of the device 10 via a user interface module that may be used as the system controller to define/provide key parameters such as maximum allowable angle of flexion (typically established by the physiotherapist/doctor), speed (typically set by a user within allowable limits) and may act as a display during operation. The user interface module 4 may have a data storage feature and may be detachable from the device so that it may be carried to a physiotherapist for review of user activity and/or to change control parameters if needed. Alternatively, a wireless communications module 22 may be used to transmit user activity information to the physiotherapist and remotely receive changes in control parameters to change the parameters in the control unit 21. As a result, the device 10 may operate as part of a rehabilitation system with access to and from the device 10 via external communications such as the wireless module 22.

The control unit 21 may receive signals from a torque sensor 20 that is placed in line with the drive shaft connected to the motor 7. The control unit 21 may use these signals to send relevant communication to the control unit 21 for use in controlling the device 10. Alternatively, several other techniques for measuring force feedback from the patient can be used instead of the torque sensor, some of which may be measurement of back current in the drive or motor, use of force transducers placed on the trough or any other convenient feedback location on the drive shaft or base. The control unit 21 may further receive position information from a position sensor mounted on the drive shaft allowing for a calibration of the angular position of the trough and/or the angular speed. Alternatively, among other alternatives, back EMF of the motor may be used to determine rotational speed of the trough or a position sensor may be integral to the motor drive unit. A regeneration unit 11 in FIG. 7 may be required for the control unit 21 if the motor is back drivable, and it is deemed to be beneficial. The control unit 21 may contain an embedded current and voltage sensor for control purposes.

The active-passive rehabilitation device described herein provides several advantages over traditional knee CPM devices. Examples of some of the features, advantageous and/or improvements provided by the active-passive rehabilitation device are described below.

One aspect is that the rehabilitation device as described herein provides for natural and relatively unconstrained motion of the treated extremity (e.g., knee joint) by eliminating the constraining forces placed upon the extremity by straps and by a foot plate in conventional devices, thereby allowing the extremity to glide, rotate and translate naturally and biometrically at the joint. This ability of the extremity to flex and extend in the rehabilitation device described herein without the usual constraining and applied moment forces seen in a traditional CPM therefore results in a significantly less amount of force being imparted onto the treated joint during therapeutic motion. The knee rehabilitation device ensures with its kinetics that the user's calf section moves posterior to the Coronal plane in a plane inclined to the Sagittal plane during the flexion cycle and anterior to the coronal plane during maximum allowable extension thereby ensuring a natural flexion-extension regime of rehabilitative motion for the user as opposed to motion generated by conventional devices. The motion also eliminates pinching between the thigh and upper torso.

The knee rehabilitation device also permits the user to be treated without having to be positioned on his/her back and supine. The active-passive rehabilitation device allows the user to be positioned at varying positions and degrees of lateral recumbency. This feature allows the user to assume greater positional comfort while engaged with the active-passive rehabilitation device, thus maximizing user comfort and also decreasing the likelihood of adverse events due to static positioning of the user, such as sacral decubiti (bed sores) and deep venous thrombosis (extremity blood clot formation), which are some recognized major complications for which knee surgery patients are at high risk.

The rehabilitation device promotes the dependent drainage of operative and injury induced edema (swelling) from the entire treated extremity by maintaining elevation of the user's extremity above the user's heart while using the device. For example, if the rehabilitation device is a knee rehabilitation device, the user's thigh, knee, leg, ankle and foot are maintained in a position above the user's heart level while using the active-passive rehabilitation device. This effect is also enhanced by the cant angle, alpha, of the drive shaft and therefore the trough (see FIG. 2). Decreased edema is a recognized therapeutic and surgical goal in promoting post-operative rehabilitation of the extremity and the reduction of several complications known to be associated with edema formation.

The rehabilitation device enables easy application of simultaneously applied adjunctive therapeutic modalities. That is, separate therapeutic modalities, such as cryotherapy pack units and pneumatic sequential compression devices can be easily and more readily applied to the user for treatment due to the lack of constraining and interfering restraint straps in the rehabilitation device described herein.

The rehabilitation device reduces the number of points of force application delivered by the device upon the distal portion of the extremity during therapeutic motion cycles. In the embodiment where the rehabilitation device is configured for rehabilitation of the knee joint, this factor is due to the lateral positioning of the user's leg in a nonconstrained sling support, (i.e., trough 3) which eliminates the concentrated areas of force imparted upon the user's distal portion of extremity by straps and a foot plate of conventional devices. The extremity is thusly moved with a more, and nearly, even distribution of induced therapeutic pressures applied by the active-passive rehabilitation device while also allowing the extremity and knee joint to slide and rotate while following its natural and biometric motion during the CPM flexion/extension cycle.

The active-passive rehabilitation device configuration provides significant more ease of use and increased favorable work ergonomics on the part of both the user and caregivers as the user is placed into and taken out of the active-passive rehabilitation device. This is due in part because there is no need for restraining straps, along with its relatively small size and weight as compared to conventional CPM products.

The rehabilitation device facilitates rehabilitation postoperatively, for a wide range (i.e. many different kinds) of surgeries.

The rehabilitation device provides parametric controls via embedded software which provides physical therapists, surgeons and nurses the ability to program specific therapeutic parameters including, but not limited to, the therapeutic motion arc though which the extremity should be exercised, the speed at which the trough should be moved through this range of motion arc, variations in speed which are associated with smaller and particular discrete values of range of motion within the larger range of motion arc, and sub cycles of back and forth (flexion and extension) motion during which the direction of motion varies changes in a prescribed way, within the larger range of motion arc. Settings for these therapeutic parameters may be configured such that they may be pre-set by the care giver (e.g., therapist, nurse, etc.) and not be changeable by the user in their mode and values, preset by the care giver or adjustable by the user as advised by the care giver, and/or, preset as having the condition of some of the aforementioned parameters being controlled by the user and others not adjustable by the user, in any combination.

The permutations of control of therapeutic parameters listed above are some of the possible configurations which allow the care giver and user to participate in the therapeutic cycle in a variety of agreed and/or pre programmed parameter combinations that are either care giver controlled or user controlled, as prescribed by the surgeon or other doctor and carried out by the user and other appropriate care givers. Such interaction between prescribing surgeon and/or doctor, care givers and users functionally, emotionally and therapeutically empowers all “stakeholders” in the therapeutic process to actively participate together as a therapeutic team. Furthermore, such participation by the user in the setting of and alteration of these therapeutic parameters, as prescribed, allows the user to participate in the control of their pain and participate in the manner of therapeutic cycle that the user feels to be most effective during their use of the device.

The rehabilitation device provides both software and hardware that permits the surgeon, caregiver(s) and user to obtain historical active-passive rehabilitation device and user performance information and therefore receive information as to the user's therapeutic performance, preferences and progress. The information may be provided via BlueTooth, Internet, modem, website, a memory card imbedded with the device, and/or other similar technologies. Furthermore, the software and active-passive rehabilitation device input and therapeutic prescription parameters may also be adjusted as input via these same transfer methods. The active-passive rehabilitation device may also have the programmable option of providing Active Range of Motion or Active Resistive Range of Motion (AROM or ARROM) for prescribed therapeutic cycles. That is, in addition to passively moving the user's extremity throughout the therapeutic cycle, an option to require the users to wholly or partially actively move the treated extremity to assist in the accomplishment of therapeutic range of motion cycles exists. Furthermore, the software may provide a resistive feature which requires the user to actively push on the device against a preprogrammed level of resistance in order for the therapeutic cycle to be completed, for example. This capability may be activated by enabling four quadrant control in the motor controller. A further capability and advantage with this control approach is that the motor torque can be estimated based on the current magnitude and vector, or with the use of a torque sensor. With this information, user input torque and power can be recorded for historical data purposes and to measure therapeutic progress.

The rehabilitation device is configured to be easily stored due to the compact dimensions, reduced weight and configuration of the device. It may be conveniently and safely stored at the foot of the user's bed, and under the bed when not in use. This may be accomplished by way of an integrated stabilization 14 and/or bed attachment clamp device 6. Alternatively, the modular design enables the unit to be stowed with minimum space requirements in a convenient location.

The rehabilitation device may be provisioned and configured such that caregivers or other interested parties can communicate with the control unit via cellular telephone, Internet, or other similar modes of communication. With the remote communication capability, historical data may be downloaded as described above, and new exercise parameters may be uploaded described above. This communication capability can also be used to diagnose equipment functionality and failures, and can even be used for equipment prognostics and health monitoring.

The rehabilitation device is configured to include a support structure 13 for the proximal portion of the extremity as seen in FIG. 3 for those users requiring additional support and stability. This support structure 13 in one embodiment configured for rehabilitation of the joint generally conforms to the approximate size and contours of a user's extremity, and enables pressure distribution in order to avoid circulation restriction and high pressure points, as described above. The support structure 13 may be constructed of a rigid plastic, and may be padded with conformable material such as viscoelastic memory foam and/or a sheepskin material, for example. In addition, the support structure 13 in one embodiment of the rehabilitation device configured for rehabilitation of the knee joint is configured to aid in preventing inner rotation of the femur, by supporting only the thigh and allowing natural flexion of the distal portion of the leg below the knee joint.

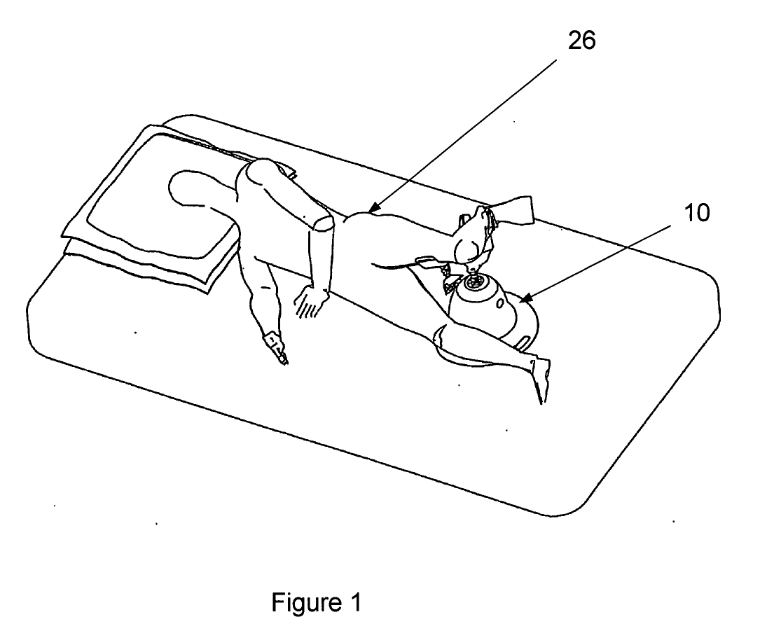

Bed attachment clamps 6 and optional telescoping stabilizers 14 may be utilized depending on the application. These stabilizers can also be used as carrying handles, and can even be used in conjunction with wheels attached to the base, much like modern luggage, thus promoting ease of transport and handling. In another aspect, a further stabilization feature associated with the active-passive rehabilitation device configured for rehabilitation of the knee joint is the inherent use of the user's “idle” leg as a weight to add stability to the base in the configuration as shown in FIGS. 1 and 3.

The rehabilitation device is also configured to provide a safety feature due to the torque limited permanent magnet brushless DC motor and motor controller. With this type of motor controller, the maximum torque that can be generated by the active-passive rehabilitation device is a function of the motor controller output current. The current set point may be preset to a therapeutically safe level, irrespective of the maximum capability of the motor. The same principles apply to a stepper motor An AC motor with hardware frequency limits can achieve the same safety objectives. Additionally, safety features that monitor the position and speed of the trough during the rehabilitative cycle can be incorporated. Further, safety features which monitor whether mechanical aspects of the rehabilitative device, for example, the left right engage lever are appropriately engaged during the entire rehabilitative cycle can be incorporated. Also, provisions for safety during operation can be incorporated, for example, during the user activated mode of operation, a safety timer may allow the trough to come back to an angular preferred position from full flexion if the torque sensor does not see the desired force input by the user to trigger activation of the cycle after a pre-determined period of time. This feature is designed to incorporate the eventuality that the user may have fallen asleep during the rehabilitative process or cannot apply the pre-determined force level required to activate the rehabilitative device from full flexion back to extension.

In conjunction with adjunctive therapeutic capabilities, such as cryo-coolers, in different embodiments, the active-passive rehabilitation device may also employ alternative motor technologies. In one alternate embodiment, a hydraulic motor, such as a piston motor or a vane motor, may be used to generate motive torque to drive the active-passive rehabilitation device. The hydraulic power source for this motor may be a cryo-cooler pump system. Based on the operating pressure level of this system, power density of the hydraulic motor may be greater than that for the electric motor. A bi-directional servo-valve may be used to provide the control functions as described above. In another alternate embodiment, a pneumatic source, similar to that used for a ventilated mattress or oxygen concentration system, for example, may be used as the motive power. Further, this power density may be achieved independent of the cryo-cooler system, utilizing an entirely independent hydraulic, or pneumatic, source as appropriate.

In alternate embodiments where the rehabilitation device has been configured for rehabilitation of the knee joint, the calf/leg trough or “sling support” described above may be comprised of two separate parts to accommodate variations in leg length and foot amongst users. The length of the two-piece trough may be adjusted according to the user's particular geometry. Further, a single piece trough may be utilized with an adjustment feature that allows it to be slid away from the axis of rotation. Alternatively and/or additionally, the trough itself may be shaped in a slight curve such that it conforms to the user's leg. Alternatively and/or additionally, the stiffness coefficient of the trough assembly can be selected such that it acts as a spring reacting to the weight of the extremity, thus providing a degree of conformity to the user's extremity, and allowing for an even load distribution over the length of the extremity. In one embodiment of the rehabilitation device configured for rehabilitation of the knee joint, a height adjustment may be used to accommodate variations amongst user hip widths. A measurement marking on the shaft allows a therapist to adjust the height to a therapeutically optimum height such that the knee and leg are elevated and load pressures are minimized. With this single adjustment, the therapeutic benefits described above may be achieved without the need for an optional trough angle adjustment. The trough angle is maintainable at a therapeutically optimum angle. It will be appreciated by one skilled in the art that the angle Alpha can be accommodated in the base design, thereby allowing for a relatively simple design of the drive mount bracket. Further, adjustments in angle Alpha may be incorporated into the design by using bearings of varying geometries where the drive mount bracket is supported by the base.

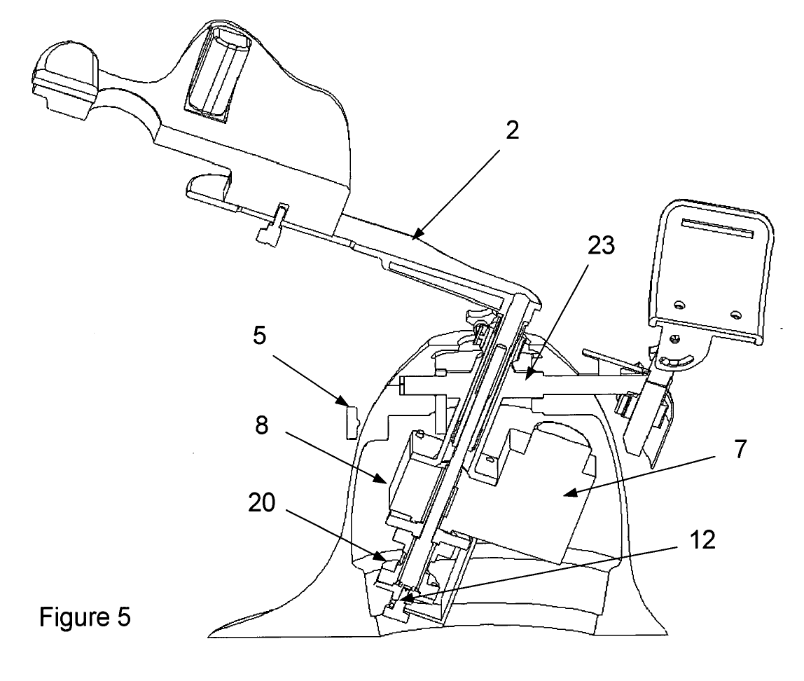

The rehabilitation device includes a castor angle adjustment, Beta, which may be changed based on which the leg is being exercised using a left/right leg engage lever 5 FIG. 5. This adjustment promotes comfort and mitigates the possibility of internal rotation.

Alternatively, embodiments without a castor angle may be desirable in certain situations, thereby making the design simpler to manufacture and assemble.

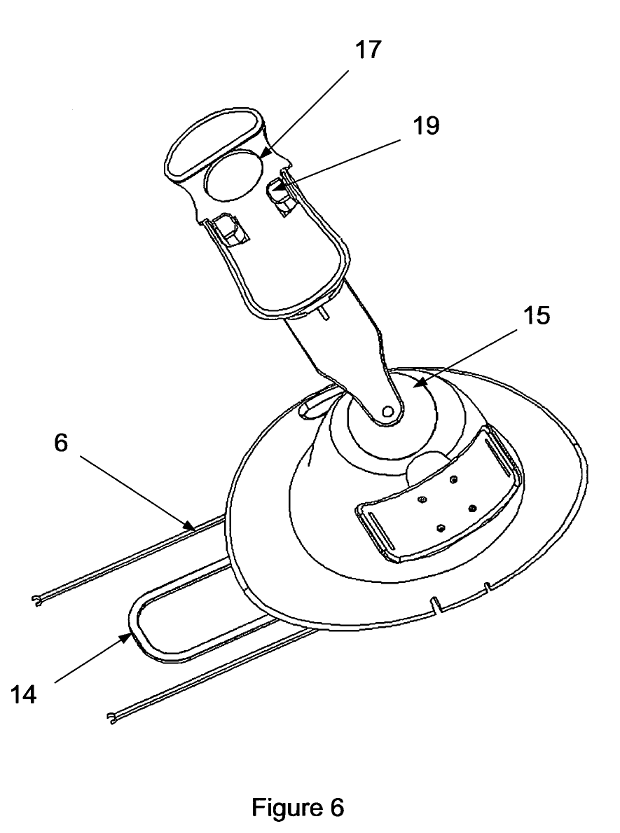

The contacting base part of the active-passive rehabilitation device in contact with a supporting surface (such as a bed or a floor) may have a material with a high co-efficient of friction such that the possibility of the active-passive rehabilitation device moving relative to the support surface during operation is mitigated. The contacting base part may permit the base to be partially open, for example, or the contacting base may fully close across the base to provide more contacting surface. The base may accommodate an extendable-retractable stabilizing bar system 14 or maybe shaped as a fluted base 1 that captures the healthy leg and uses its weight to provide stability. This base may be constructed of a rigid plastic material with a ventral surface that has a high coefficient of friction relative to typical bedding and/or flooring material, and may further be padded on the dorsal/top surface with a viscoelastic foam and/or sheepskin material. A cap structure 15 may be incorporated in one embodiment as seen in FIG. 6, overlaying a part of the base structure. The cap member prevents the entry of foreign objects into the base structure where the electromechanical components may be housed. Further, the cap member may be co-axial to the drive shaft and its surface may engage with the base structure thereby providing structural rigidity and allowing the forces on the driveshaft load path to be minimized. Finally, in one embodiment where the rehabilitation device has been configured to rehabilitate the knee joint, the base 1 can extend beyond the locus of rotation of the leg center of mass in order to counteract the tipping moment of the leg in the trough.

In one embodiment, a laser alignment system may be accommodated to guide alignment between the user's extremity axis of rotation with the machine axis of rotation. In another embodiment a surface feature 17 in the trough as seen in FIG. 6 such as a bore or a hole would allow the user to position their extremity relative to the surface feature, for example, in the embodiment for the rehabilitation of the knee joint by allowing positioning of the lateral malleolus with respect to the surface feature, thereby allowing the user to line up their joint undergoing rehabilitation with the axis of rotation of the trough. Further, this surface feature allows for the accurate adjustment of the length of the trough and/or distance of the trough from the axis or rotation of the trough at the time of initial setup. In one embodiment of the rehabilitation device configured for rehabilitation of the knee joint, ankle pads 19 may be incorporated in the trough as seen in FIG. 6 allowing for a snug fit of the user's extremity in the trough, further assisting in accurately positioning the extremity in the trough so as to line up the axis of rotation of the joint with the axis of rotation of the trough.

In yet another embodiment, the active-passive rehabilitation device is configured so that it would require very little adjustment to accommodate the various sizes and weights of the user population. In an active-passive rehabilitation device for the knee, this is accomplished by configuring a trough pivot located approximately 7 inches below the knee. When the raised leg is in extension, the pivot accommodates situational variations such as users with genu valgum (knock knee) or genu varum (bow-legged), for example. Moreover, as the leg is rotated in flexure, the combination of partial thigh weight may be offset by the overhanging moment of the lower leg, creating a natural balance. This balance point is at the trough pivot point. This pivoting degree of freedom also permits the leg to follow minor repositioning of the hips by the user in effort to remain comfortable.

In addition to the features, advantageous and/or improvements outlined above, the active-passive rehabilitation device includes features which effectively eliminate the common problem of Buttock and gluteal fold impingement as often seen with conventional lower extremity CPM designs.

The active-passive rehabilitation device also empowers users during their own therapeutic treatment by incorporating a user control interface, which in one embodiment is preferably incorporated as a hand held pendant (however in other embodiments, it may be incorporated integral to the base or the control unit) and related software operating in a suitable microprocessor which allows the user to directly and manually control the therapeutic device parameters of range of motion and speed of motion within the prescribed pre-programmed and therapeutic limits as set by the user's caregiver. The active-passive rehabilitation device does not capture the extremity with straps or other constraints such as a plantar foot plate and as such it is easy to lift, apply, remove and store, such as storage within the bed at its foot and attachable to the bed, for safety and convenience. The active-passive rehabilitation device provides hardware and software to enable a transferable record of tracked therapeutic and user performance data for the use of the user, physical therapist, physician or other care giver.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

The disclosures of any references and publications cited above are expressly incorporated by reference in their entireties to the same extent as if each were incorporated by reference individually.

We claim:

1. An apparatus for rehabilitating a user's joint of an extremity having a proximal portion and a distal portion attached at said joint, comprising:
a trough configured to receive at least a portion of a user's distal portion;
a drive shaft coupled to said trough at one end;
a drive coupled to said drive shaft and a drive mount bracket; said drive mount bracket rotatably supported by a base, said base having a mount surface and providing support against a supporting platform;
a control unit to provide and receive control inputs and outputs, said control unit in communication with said drive and configured to control movement of said trough.

2. The apparatus of claim 1 further comprising at least one torque sensor mounted on said drive shaft providing a force feedback measurement to said control unit.

3. The apparatus of claim 2 further comprising at least one position sensor mounted to said drive shaft, said position sensor providing position input to said control unit.

4. The apparatus of claim 3, said trough is inclined in relation to a horizontal plane that is coplanar with said supporting platform during operation.

5. The apparatus of claim 4, said trough during operation is inclined in relation to a plane vertically bisecting the base.

6. The apparatus of claim 5 further comprising a support structure for said proximal portion, said support structure coupled to said drive mount bracket, said support structure for said proximal portion configured to allow motion to accommodate variation in physical attributes of users.

7. The apparatus of claim 6 further comprising a user interface module in communication with said control unit and configured to receive user input to allow a user to vary at least one control parameter to control motion of said trough.

8. The apparatus of claim 7, said drive shaft is further configured to provide adjustments in distance of said trough relative to said base.

9. The apparatus of claim 8, said support structure is configured to provide adjustments in distance of said trough relative to said base.

10. The apparatus of claim 9, said base comprises at least one extendable feature to increase stability during operation.

11. The apparatus of claim 9, said trough further comprises a surface feature to allow a user to locate the extremity during ingress and operation with respect to said apparatus.

12. The apparatus of claim 9 further comprising a cap member co-axially coupled to said drive shaft, said cap member overlays said base.

13. The apparatus of claim 9 further comprising a wireless communication module in communication with said control unit to remotely receive and send commands and communications.

14. The apparatus of claim 13 wherein the wireless communication module is in communication with at least any one of a caregiver's computer, a personal digital assistant, a cellular phone, and a host computer.

15. The apparatus of claim 9 further comprising a torsional spring coupled between said trough and said drive shaft.

16. The apparatus of claim 9, said trough comprising two trough portions, each trough portion independently slidably mounted on said drive shaft allowing for adjustability in the length of said trough.

17. An apparatus for rehabilitating a user's joint of an extremity having a proximal portion and a distal portion attached at said joint, comprising:
a trough configured to receive a portion of the a user's distal portion;
a drive shaft coupled to said trough at one end;
a drive coupled to said drive shaft and a drive mount bracket rotatably supported by a base, said base having a mount surface and providing support against a supporting platform;
a control interface module in communication with said drive and configured to receive user input to allow the user to vary at least one control parameter to control motion of said trough.

18. The apparatus of claim 17 further comprising a control unit to provide and receive control inputs and outputs, said control unit in communication with said control interface module.

19. The apparatus of claim 18 further comprising at least one torque sensor mounted on said drive shaft providing a force feedback measurement to said control unit.

20. The apparatus of claim 18 further comprising at least one position sensor mounted to said drive shaft, said position sensor providing input to said control unit.

21. The apparatus of claim 18 further comprising a wireless communication module in communication with said control unit to receive and send commands and communications to at least any one of a caregiver's computer, a personal digital assistant, a cellular phone, and a host computer.

22. The apparatus of claim 17, said control interface module further comprising a control unit to provide and receive control inputs and outputs.

23. The apparatus of claim 22 further comprising at least one torque sensor mounted on said drive shaft providing input to said control unit.

24. The apparatus of claim 22 further comprising at least one position sensor mounted to said drive shaft, said position sensor providing input to said control unit.

25. The apparatus of claim 22 further comprising a wireless communication module in communication with said control unit to receive and send commands and communications to at least any one of a caregiver's computer, a personal digital assistant, a cellular phone, and a host computer.

26. The apparatus of claim 17, said trough during operation is inclined in relation to a horizontal plane coplanar with said supporting platform.

27. The apparatus of claim 17, said trough during operation is inclined in relation to a plane vertically bisecting the base.

28. The apparatus of claim 17 further comprising a support structure for said proximal portion, said support structure coupled to said base, said support structure for said proximal portion configured to allow motion to accommodate variation in physical attributes of users.

29. The apparatus of claim 17, said drive shaft configured to provide adjustments in distance of said trough relative to said base.

30. The apparatus of claim 17, said base comprising at least one extendable feature to increase stability during operation.

31. The apparatus of claim 17, said trough further comprises a surface feature to allow users to locate the extremity during ingress and operation with respect to said apparatus.

32. The apparatus of claim 17 further comprising a cap member co-axially coupled to said drive shaft, said cap member overlays said base and serves to prevent entry of foreign objects in said apparatus.

33. The apparatus of claim 17 further comprising a torsional spring coupled between said trough and said drive shaft.

34. The apparatus of claim 17, said trough comprising two trough portions, each trough independently slidably mounted on said drive shaft allowing for adjustability in the length of said trough.

35. A method for providing rehabilitative therapy to a user's joint of an extremity having a proximal portion and a distal portion attached at said joint, the method comprising:
enabling a natural range of motion of the user's said distal portion in flexion and extension with respect to the Coronal plane of the user; and
enabling motion of the user's said distal portion in a plane inclined to the user's Sagittal plane to reduce the likelihood of dislocation of the extremity.

36. The method of claim 35, further including providing an active resistive activation feature which allows a user to initiate the rehabilitative therapy cycle by exceeding a force threshold pre-determined by a caregiver.

37. The method of claim 36, further including a providing an active resistive feature which allows the user to exert a predetermined force through the entire rehabilitative cycle.

38. A method for providing rehabilitative therapy to a user's joint of an extremity having a proximal portion and a distal portion attached at said joint, the method comprising:
enabling a natural range of motion of the user's said distal portion in flexion and extension with respect to the Coronal plane of the user;
enabling motion of the user's said distal portion in a plane inclined to the user's Sagittal plane to reduce the likelihood of dislocation of the extremity;
providing at least one of a visual and audio indication of the status of the rehabilitative cycle to the user during operation.

39. The method of claim 38, further including providing an active resistive activation feature which allows a user to initiate the rehabilitative therapy cycle by exceeding a force threshold pre-determined by a caregiver.

40. The method of claim 38, further including providing an active resistive feature that allows the user to exert a predetermined force through the entire rehabilitative cycle.

41. An apparatus for rehabilitating a user's joint of an extremity having a proximal portion and a distal portion attached at said joint, comprising:
a trough configured to receive at least a portion of user's said distal portion;
a drive configured to couple to said trough and supported by a base, said base having a mount surface and providing support against a supporting platform; and
a control unit to provide and receive control inputs and outputs, said control unit in communication with said drive and configured to control movement of said trough.

42. A method for providing rehabilitative therapy to a user's knee joint of a leg having a femoral portion and a tibial portion attached at said joint, the method comprising:
enabling a natural range of motion of the user's said tibial portion in flexion and extension with respect to the Coronal plane of the user;
enabling motion of the user's said tibial portion in a plane inclined to the user's Sagittal plane to reduce the likelihood of dislocation of the leg;
providing at least one of a visual and audio indication of the status of the rehabilitative cycle to the user during operation; and
enabling elevation of at least a portion of the user's leg above the user's heart during at least a portion of the rehabilitative motion.

43. A method for providing rehabilitative therapy to a user's joint of an extremity having a proximal portion and a distal portion attached at said joint, the method comprising:
providing an active resistive activation feature which allows a user to initiate the rehabilitative therapy cycle by exceeding a force threshold; the force applied by the extremity; said force threshold pre-determined by at least any one of a caregiver and a user.

44. The method of claim 43, further including providing an active resistive feature that allows the user to exert a predetermined force through the entire rehabilitative cycle.
